(19) United States
(12) Patent Application Publication
(10) Pub. No.: US 2025/0076668 A1
(43) Pub. Date: Mar. 6, 2025

(54) SELECTABLE GAUSSIAN AND RING BEAM CHARACTERISTICS

(71) Applicant: nLIGHT, Inc., Camas, WA (US)

(72) Inventors: Roger L. Farrow, Vancouver, WA (US); Dahv A.V. Kliner, Portland, OR (US); Juan Carlos LUGO, Vancouver, WA (US); Brendan G. O'DEA, Camas, WA (US)

(21) Appl. No.: 18/696,775

(22) PCT Filed: Sep. 30, 2022
(86) PCT No.: PCT/US2022/077371

§ 371 Date: Mar. 28, 2024

Related U.S. Application Data
(60) Provisional application No. 63/262,491, filed on Oct. 13, 2021.
(60) Provisional application No. 63/262,029, filed on Oct. 1, 2021.

(51) Int. Cl. G02B 27/09; G02B 6/036; G02B 6/14; G02B 6/26

(52) U.S. Cl. CPC G02B 27/0994; G02B 6/03605; G02B 6/14; G02B 6/262; G02B 27/0927

(57) ABSTRACT

Disclosed are optical beam delivery devices and methods to produce, from a single-mode input beam having a fundamental mode and an M² beam quality of about 1.5 or less, an output beam having an adjustable spatial intensity distribution that is adjustable between near Gaussian and ring-shaped profiles, the near Gaussian profile corresponding to an M² beam quality of about 1.5 or less. A first length of optical fiber is for adjusting the single-mode input beam to generate an adjustable beam based on controllable perturbation applied to the first length of optical fiber. A second length of optical fiber is for coupling the adjustable beam into one or both a central core confinement region and an annular higher-index confinement region. The second length of optical fiber is configured to provide at its output the output beam having the adjustable spatial intensity distribution.

### CROSS-REFERENCE TO RELATED APPLICATIONS

This application claims the benefit of U.S. Provisional Patent Application No. 63/262,029, filed Oct. 1, 2021, and U.S. Provisional Patent Application No. 63/262,491, filed Oct. 13, 2021, the disclosures of which are hereby incorporated by reference herein it their entirety.

### TECHNICAL FIELD

The technology disclosed herein relates to fiber lasers and fiber-coupled lasers. More particularly, the disclosed technology relates to methods, apparatus, and systems for tuning a single-mode input beam to a ring-shaped beam.

### BACKGROUND INFORMATION

Some laser sources have a fixed beam profile and make use of external optics to change the beam profile, which increases system cost and complexity and can degrade performance and reliability. In contrast, as described in U.S. Pat. No. 10,423,015, titled “Adjustable Beam Characteristics,” and its related patents, nLIGHT, Inc. developed technology for varying beam properties by controlling a spatial intensity distribution of a laser beam, i.e., adjusting its near-field intensity distribution.

The '015 patent describes a fiber operable to provide a laser beam having variable beam characteristics (VBC) that may reduce cost, complexity, optical loss, or other draw backs of the conventional methods. This VBC device is configured to vary a wide variety of optical beam characteristics. Such beam characteristics can be controlled using the VBC device thus allowing users to tune various beam characteristics to suit the particular requirements of an extensive variety of laser processing applications. For example, a VBC device may be used to tune the following: beam diameter, divergence distribution, BPP, intensity distribution, M² factor, numeric aperture (NA), optical intensity, power density, radial beam position, radiance, spot size, or the like, or any combination thereof.

In some embodiments, the '015 patent describes adjusting the coupling of the beam into a so-called ring fiber, which has two or more guiding regions. A ring fiber has one or more annular cores optionally surrounding a central (non-annular) core, with low-index glass layers separating the cores so that light coupled into a core will be guided in that core. To achieve a variety of beam diameters and shapes using embodiments and techniques described in the '015 patent, it is possible to divide the spatial intensity distribution of a laser beam coupled to a ring fiber between two or more guiding zones of the fiber. Previous attempts, however, have employed multi-mode beams.

In applications of laser-based cutting and additive manufacturing tools, it is often advantageous to use the smallest possible beam waist for processing. Such beams have a near-Gaussian transverse spatial profile and allow cutting thin material at high speeds, drilling very small holes, and fabricating parts with fine features. The high intensity, small spot size, and peaked intensity distribution, however, are not well suited for applications where larger or more uniform thermal profile are needed to maximize speed, part quality, or appearance. For these use cases, a large spot size has advantages including allowing more power to be used without excessively increasing the intensity. consequently increasing throughput. Other applications are improved by using a non-Gaussian profile, such as top-hat or ring-shaped beam, both of which avoid excessive intensity at the center of the spot that can result in material vaporization or spattering. In laser powder-bed fusion (an additive manufacturing technology), a ring-shaped beam has been shown to provide a melt pool with a more uniform temperature compared to other beam shapes, resulting in significantly higher build rates (by up to 7×) while maintaining excellent material quality and consistency.

### SUMMARY OF THE DISCLOSURE

This disclosure describes embodiments for an optical beam delivery device that enables a laser beam shape to be tuned from a single-mode (near-Gaussian) profile to a ring-shaped beam, as well as other intermediate saddle shapes that allow tailoring of heat applied in some processes.

In some embodiments, an optical beam delivery device produces, from a single-mode input beam having a fundamental mode and an M² beam quality of about 1.5 or less, an output beam having an adjustable spatial intensity distribution that is adjustable between near Gaussian and ring-shaped profiles. The near Gaussian profile corresponds to an M² beam quality of about 1.5 or less. The optical beam delivery device includes a first length of optical fiber for adjusting the single-mode input beam to generate an adjustable beam based on controllable perturbation applied to the first length of optical fiber. In response to the first length of optical fiber being unperturbed, the single-mode input beam propagates through a central region of the first length of optical fiber to provide the adjustable beam. In response to the controllable perturbation, the fundamental mode is at least partly displaced into an outer region of the first length of optical fiber to provide the adjustable beam. The optical beam delivery device also includes a second length of optical fiber for coupling the adjustable beam into one or both a central core confinement region and an annular higher-index confinement region of a second length of optical fiber. The annular higher-index confinement region coaxially encompasses an annular anti-guiding region separating the central core confinement region from the annular higher-index confinement region. The second length of optical fiber is configured to provide at its output the output beam having the adjustable spatial intensity distribution that is adjustable between the near Gaussian and ring-shaped profiles.

The optical beam delivery device may also include the central core guiding region having a radius in a range from about three um to about 15 μm. The optical beam delivery device may also include a coupling efficiency greater than 95% for the central region of the first length of optical fiber and the central core confinement region of the second length of optical fiber. The optical beam delivery device may also include the controllable perturbation having different states of bending of the first length of optical fiber. The optical beam delivery device may also include a refractive index of the annular anti-guiding region resulting in an NA in a range that is greater than or equal to about 0.04 and less than or equal to about 0.1 for guidance of the central core confinement region, and the annular high-index confinement region has a refractive index resulting in an NA in a range that is greater than or equal to about 0.12 and less than or equal to about 0.2 for the guidance of the annular high-index confinement region. The optical beam delivery device may also include an NA of the annular higher-index confinement region that is about 0.14 and an NA of the central core confinement region that is about 0.07. Other technical features may be readily apparent to one skilled in the art from the following figures, descriptions, and claims.

The foregoing and other objects, features, and advantages will become more apparent from the following detailed description, which proceeds with reference to the accompanying figures, which may not be drawn to scale.

### BRIEF DESCRIPTION OF THE DRAWINGS

To easily identify the discussion of any particular element or act, the most significant digit or digits in a reference number refer to the figure number in which that element is first introduced.

FIG. 1 is a side view of an optical beam delivery device that is shown in its unbent position.

FIG. 2 is a side view of an optical beam delivery device of FIG. 1 that is shown in its bent position.

FIG. 3 is a graph showing a fundamental mode when a fiber in the optical beam delivery device of FIG. 1 and FIG. 2 is perturbed.

FIG. 4 is near-Gaussian spatial intensity distribution (upper portion of FIG. 4) and a corresponding near-Gaussian beam profile and refractive index profile (RIP) (lower portion of FIG. 4).

FIG. 5 is ring-shaped spatial intensity distribution (upper portion of FIG. 5) and a corresponding ring-shaped beam profile and refractive index profile (RIP) (lower portion of FIG. 5).

FIG. 6 is a set of spatial intensity distributions for different corresponding bend profiles.

FIG. 7 is a flow chart of a method of producing, from a single-mode input beam having a fundamental mode and an M² input beam quality of about 1.5 or less, an output beam having an adjustable spatial intensity distribution.

### DETAILED DESCRIPTION OF EMBODIMENTS

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally. the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus' are referred to as “lowest,” “best,” “minimum,” or the like. It will be appreciated that such descriptions are intended to indicate that a selection among many used functional alternatives can be made, and such selections need not be better, smaller, or otherwise preferable to other selections. Examples are described with reference to directions indicated as “above,” “below,” “upper,” “lower,” and the like. These terms are used for convenient description. but do not imply any particular spatial orientation. Moreover, in the following examples, laser components and assemblies are described at a high level of abstraction and do not include a complete description of all mechanical, electrical and optical elements necessary for operation.

As used herein, optical radiation refers to electromagnetic radiation at wavelengths of between about 100 nm and 10 μm. and typically between about 500 nm and 2 μm. Examples based on available laser diode sources and optical fibers generally are associated with wavelengths of between about 800 nm and 2,000 nm. In some examples. propagating optical radiation is referred to as one or more beams having diameters, asymmetric fast and slow axes, beam cross-sectional areas, and beam divergences that can depend on beam wavelength and the optical systems used for beam shaping. For convenience, optical radiation is referred to as light or beams in some examples and need not be at visible wavelengths. Forward-propagating light or optical beams or beam portions refer to light, beams, or beam portions that propagate in a direction of normal emission. Backward-propagating light or optical beams or beam portions refer to light, beams, or beam portions that propagate in an opposite direction of normal emission.

Representative embodiments are described with reference to optical fibers, but other types of optical waveguides can be used. The optical fibers or waveguides may have circular, square, rectangular, polygonal, oval, elliptical, or other cross-sections. Optical fibers are typically formed of silica (glass) that is doped (or undoped) to provide predetermined refractive index profiles. In some examples, fibers or other waveguides are made of other materials such as fluorozirconates, fluoroaluminates, fluoride or phosphate glasses, chalcogenide glasses, or crystalline materials such as sapphire, depending on wavelengths and other properties of interest. Refractive indices of silica and fluoride glasses are typically about 1.5, but refractive indices of other materials such as chalcogenides can be 3 or more. In still other examples, optical fibers can be formed in part or completely of plastics (polymers). In some examples, a doped waveguide core such as a fiber core provides optical gain in response to pumping, and core and claddings are approximately concentric. In other examples, one or more of the core and claddings are decentered, and in some examples, core and cladding orientation and/or displacement vary along a waveguide length.

In the examples disclosed herein, a waveguide core such as an optical fiber core is doped with a rare earth element such as Nd, Yb, Ho, Er, or other active dopants or combinations thereof. Such actively doped cores can provide optical gain in response to optical or other pumping. As disclosed below, waveguides having such active dopants can be used to form optical amplifiers, or, if provided with suitable optical feedback such as reflective layers, mirrors, Bragg gratings, or other feedback mechanisms, such waveguides can generate laser emissions. Optical pump radiation can be arranged to co-propagate and/or counter-propagate in the waveguide with respect to a propagation direction of an emitted laser beam or an amplified beam.

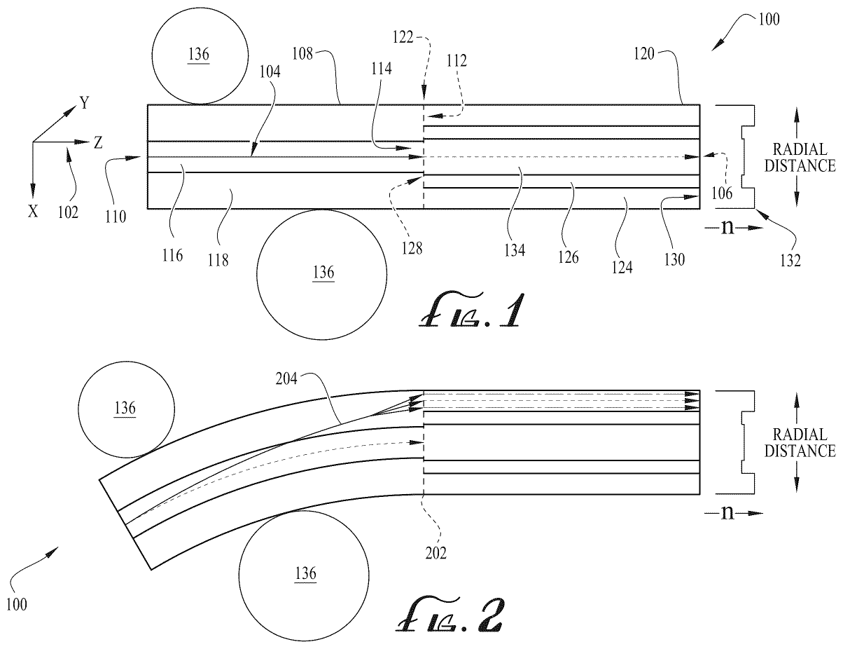

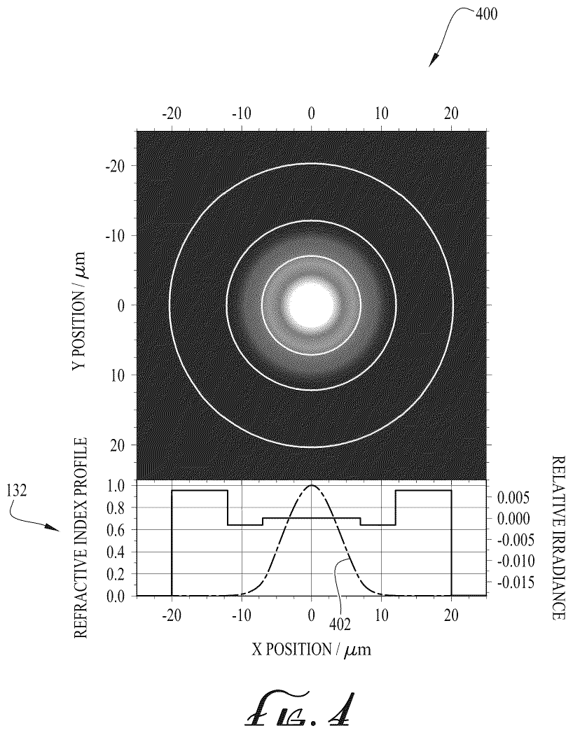

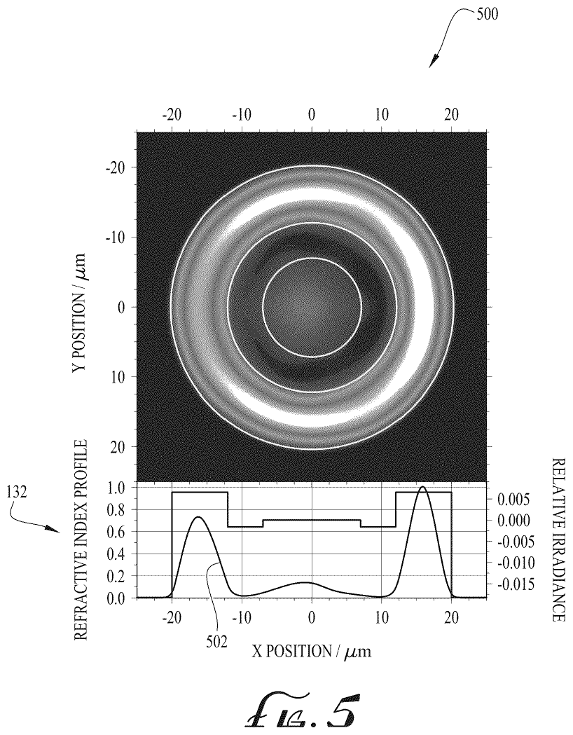

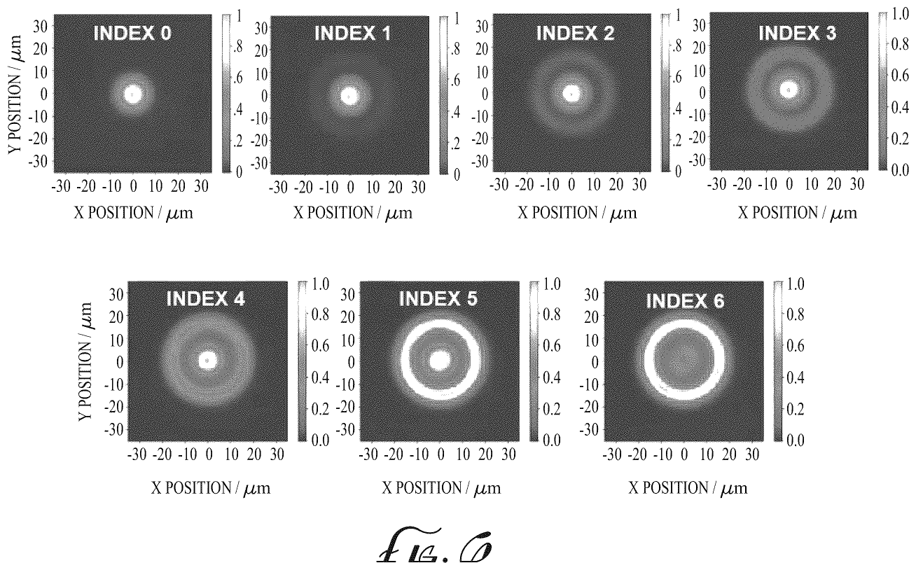

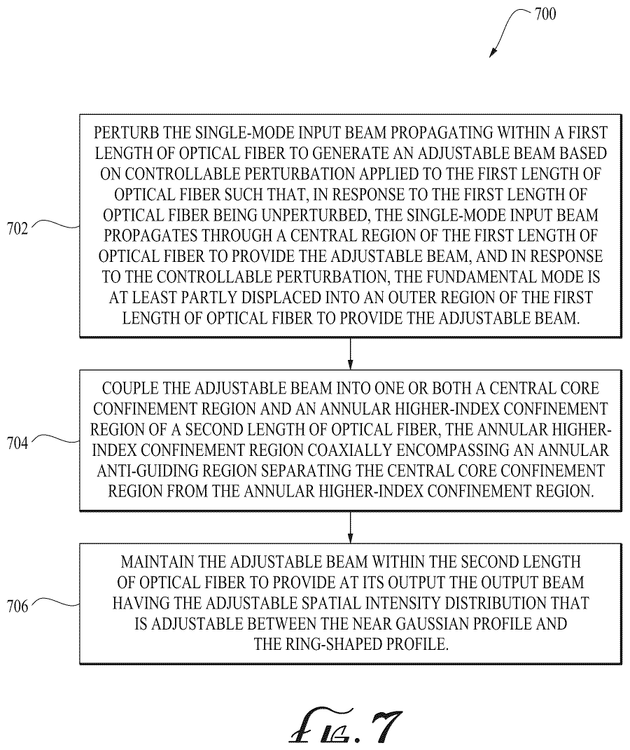

FIG. 1 shows an optical beam delivery device 100 including multiple lengths of optical fiber aligned along an optical axis 102, with refractive index profiles (RIPs) designed to tune a single-mode input beam 104 to a ring-shaped beam that, in some embodiments, is about three times wider than the width of single-mode input beam 104. Thus, the multiple lengths of optical fiber are configured to produce, from single-mode input beam 104 having a fundamental mode (see e.g., FIG. 3) and an M² input beam quality of about 1.5 or less, an output beam 106 having an adjustable spatial intensity distribution that is adjustable between near-Gaussian and ring-shaped profiles (see e.g., FIG. 4, FIG. 5, and FIG. 6). In this disclosure, the term “near-Gaussian” (i.e., M² of about 1.5 or less) encompasses a perfectly Gaussian beam while also recognizing that, in practice, beams usually include some minor deviations from a perfect Gaussian distribution that have little or no impact for the intended process.

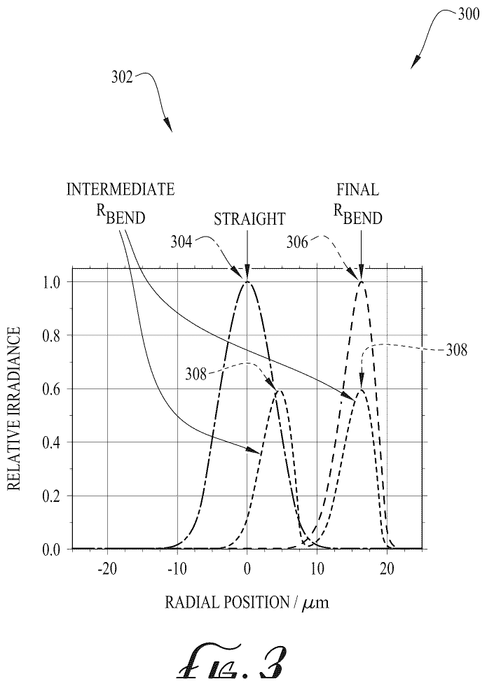

A first length of optical fiber 108 is also referred to as a bend-sensitive fiber. It includes a first input 110 configured to receive single-mode input beam 104, a first output 112 configured to provide an adjustable beam 114 (see e.g., FIG. 2 and FIG. 3), and a step-index refractive index profile corresponding to a central core guiding region 116 and an annular lower-index cladding region 118 coaxially encompassing central core guiding region 116. Central core guiding region 116 has a diameter and numerical aperture (NA) supporting a near-Gaussian mode profile. Likewise, annular lower-index cladding region 118 facilitates transverse displacement of the fundamental mode. In response to first length of optical fiber 108 being unperturbed, single-mode input beam 104 propagates through a central region of first length of optical fiber 108 to provide adjustable beam 114, and in response to the controllable perturbation, the fundamental mode is at least partly displaced into an outer region of first length of optical fiber 108 to provide adjustable beam 114. In other embodiments, first length of optical fiber 108 may be double or triple clad.

A second length of optical fiber 120, also referred to as a “ring fiber,” is coupled (i.e., splice 122) to the bend-sensitive first length of optical fiber 108 near a location of a bendable region. The ring fiber has two guiding regions: a central core guiding region 116 supporting a mode well-matched to the near-Gaussian mode of the bend-sensitive first length of optical fiber 108, and an annular higher-index confinement region 124 with the same or a larger outer diameter as that annular anti-guiding region 126. Second length of optical fiber 120 includes a second input 128 coupled to first output 112, a second output 130 configured to provide output beam 106, and a ring-fiber RIP 132. Ring-fiber RIP 132 corresponds to central core confinement region 134, an annular anti-guiding region 126 coaxially encompassing central core confinement region 134, and an annular higher-index confinement region 124 coaxially encompassing annular anti-guiding region 126.

Ring-fiber RIP 132 is designed to support a mode well matched to the incoming mode but with greatly reduced bend sensitivity. Ring-fiber RIP 132 shows that central core confinement region 134 has a refractive index that is greater than that of annular anti-guiding region 126. Annular higher-index confinement region 124 has a refractive index that is greater than that of central core confinement region 134. For example, central core confinement region 134 is fused silica surrounded by a circular depressed-index annular anti-guiding region 126. The refractive index of annular anti-guiding region 126 is depressed by a relatively small amount to provide a low NA for light traveling in central core confinement region 134, resulting in a near-Gaussian beam profile with high beam quality (M²<1.5). For example, an NA of annular higher-index confinement region 124 is about 0.14 and an NA of central core confinement region 134 is about 0.07. The diameter and NA of central core confinement region 134 as well as the thickness of annular anti-guiding region 126 are selected so that the near-Gaussian beam profile, in the case of a non-bent setting, has a radial width closely matching that of the fundamental mode of first length of optical fiber 108. This mode-matching facilitates efficient power coupling when first length of optical fiber 108 is spliced to second length of optical fiber 120 and a central-core beam produces a profile with high beam quality.

Annular higher-index confinement region 124 captures light for bend settings where optical power is intended to be divided between central core confinement region 134 and annular higher-index confinement region 124. The raised refractive index of annular higher-index confinement region 124 is raised substantially more than the depressed index is lowered, resulting in a substantially higher NA of the ring core versus the central core. This higher NA facilitates the method of shifting light from the core to the ring core at the splice between the first and second fibers in response to bending the fibers. The higher NA reduces bend loss and also guides the higher-order ring-core modes generated by the bending. In contrast, a RIP with a central core and ring core both having a similar high NA would fail to maintain the beam quality of light traveling in the central core since multiple modes would be supported and power transfer between modes would be induced by fiber bending, externally applied stresses, and other environmental perturbations.

In some embodiments, a mandrel 136 or other bending mechanism, acts on first length of optical fiber 108 and optionally second length of optical fiber 120 in the region where they are coupled together (e.g., spliced or otherwise functionally directly coupled with or without an optically inert material) to cause the profile of output beam 106 profile to be tuned. Bend profiles are engineered to reduce long term stress on the fiber(s) while achieving the desired spatial intensity distributions. Downstream of a location of splice 122. the bend profile evolves into a straight path.

To select the Gaussian beam for output beam 106, the bending mechanism applies a non-bent profile corresponding to a straight fiber path through a region of splice 122. In this case, the Gaussian-like mode of adjustable beam 114 from the bend-sensitive first length of optical fiber 108 is directed into a central core confinement region 134 of the ring fiber at the splice position. Thus, output beam 106 at second output 130 closely resembles the mode of the straight bend-sensitive fiber and thus single-mode input beam 104.

FIG. 2 shows how perturbation of first length of optical fiber 108 includes bending it in one or more axes using at least one mandrel 136. Bending the fibers at or near their junction 202 sheds at least some light 204 from adjustable beam 114 of the bend-sensitive first length of optical fiber 108 into annular higher-index confinement region 124, where light 204 it is captured to form output beam 106 in the ring/saddle shapes shown in FIG. 5 and FIG. 6.

The bending mechanism allows for switching between the non-bent and bent profiles, and the switching can be very rapid (millisecond timescale or faster, depending on the implementation). Control over the fiber paths is achieved by attaching one fiber to mandrel 136 on a rotational motor shaft and positioning a secondary contact point relative to mandrel 136. The curvature of mandrel 136, rotation angle, and position of the secondary contact point achieve a variety of fiber bend paths. The location of the splice along the bent fiber path changes coupling efficiency into the guiding ring. The variety of bend paths provides a variety of output beam intensity distributions (divisions of the laser power between the central core and the annual core of the ring fiber).

Other options for applying perturbation include use of a transducer, heat, actuators, or use of other types of perturbation shown and described with reference to FIG. 24 of the '015 patent of Kliner et al.

FIG. 3 is a plot 300 showing how a fundamental mode 302 had different fractions of light coupled into central and outer regions of bend-sensitive first length of optical fiber 108 as a function of the bend radius (i.e., the output fraction of the power between the core and ring is adjustable). With a straight (unbent) profile, fundamental mode 302 has one peak 304 and central Gaussian distribution. When first length of optical fiber 108 is bent according to a prescribed bending profile (discussed above), fundamental mode 302 shifts almost completely out of central core guiding region 116 to a position toward an outer region first length of optical fiber 108. With a final bend profile (e.g., a highest index setting for the amount of bend), fundamental mode 302 has one peak 306 and transversely displaced near-Gaussian profile. And with an intermediate bend profile, the profile of the fundamental mode 302 evolves into two peaks 308, with power localized both in central core guiding region 116 and in annular lower-index cladding region 118. Thus, some fraction of light is shed outward, based on a continuously tunable, adjustment of the spatial intensity distribution. RIP and bend parameters are designed to yield a mode closely matched to that of single-mode input beam 104 in the non-bent setting but which also results in significant modal bend sensitivity.

FIG. 4 shows a spatial intensity distribution 400 of output beam 106 when first length of optical fiber 108 is unperturbed (see e.g., STRAIGHT R_{BEND}, FIG. 3). Also shown in greater detail is ring-fiber RIP 132 and a near-Gaussian profile 402. In this configuration. there is a high amount of overlap (e.g., greater than 95%) of a fundamental mode of single-mode input beam 104 of an input fiber (not shown) with peak 304 (FIG. 3). Likewise, there is a high amount of overlap (e.g., greater than 95%) of peak 304 (FIG. 3) with a mode of near-Gaussian profile 402 having the most intensity in central core confinement region 134 of second length of optical fiber 120. Notably, the step-index mode matching depends on NA as well as radius, so central core confinement region 134 is designed with a larger radius and higher NA to reduce bend sensitivity. In some embodiments. the coupling efficiency (based on mode overlap integral) greater than 98%.

FIG. 5 shows a spatial intensity distribution 500 of output beam 106 when first length of optical fiber 108 is bent (see e.g., FINAL R_{BEND}, FIG. 3). Spatial intensity distribution 500 is in the form of a ring beam profile 502 (lower part of FIG. 5), which is multimode but has a relatively small number of modes (low M²) so has desirable focusing properties (large depth of field). As adjustable beam 114 enters annular higher-index confinement region 124, the portion of the beam which was captured expands to azimuthally fill the annular ring-shaped core, resulting in a ring beam distribution (upper part of FIG. 5). The ring fiber is designed with sufficiently strongly guiding cores to be used as the feeding fiber to deliver the near-Gaussian or the ring-beam profile to the process optics. In the ring-beam setting, a minor portion of the total power may remain in the center core (see ring beam profile 502). For cutting and additive processing it is sometimes important to be able to achieve a lower intensity in the center core compared to the annular core to realize the benefits of a ring beam. In addition, divergence of the ring beam may be sensitive to the shape of the bend profile.

Various ring diameters are possible using different fiber RIPs. The example shown in FIG. 5 has a 40 μm outside ring diameter. A larger ring could be generated by making the outside diameters larger of first length of optical fiber 108 and second length of optical fiber 120.

Various beam profiles are also possible based on different bend profiles. For example, FIG. 6 shows different beam shapes made possible at different index values of bending applied by mandrel 136 (FIG. 1 and FIG. 2). Each index represents a different amount of R_{BEND} (FIG. 3). Thus, in response to different intermediate states of controllable perturbation, different corresponding divisions of power are localized central core confinement region 134 and annular higher-index confinement region 124.

FIG. 7 shows a method 700 of producing, from a single-mode input beam having a fundamental mode and an M² beam quality of about 1.5 or less, an output beam having an adjustable spatial intensity distribution that is adjustable between near-Gaussian and ring-shaped profiles, the near-Gaussian profile corresponding to an M² beam quality of about 1.5 or less.

In block 702, method 700 perturbs the single-mode input beam propagating within a first length of optical fiber to generate an adjustable beam based on controllable perturbation applied to the first length of optical fiber such that, in response to the first length of optical fiber being unperturbed, the single-mode input beam propagates through a central region of the first length of optical fiber to provide the adjustable beam, and in response to the controllable perturbation, the fundamental mode is at least partly displaced into an outer region of the first length of optical fiber to provide the adjustable beam.

In block 704, method 700 couples the adjustable beam into one or both a central core confinement region and an annular higher-index confinement region of a second length of optical fiber, the annular higher-index confinement region coaxially encompassing an annular anti-guiding region separating the central core confinement region from the annular higher-index confinement region.

In block 706, method 700 maintains the adjustable beam within the second length of optical fiber to provide at its output the output beam having the adjustable spatial intensity distribution that is adjustable between the near Gaussian profile and the ring-shaped profile.

Having described and illustrated the general principles of examples of the presently disclosed technology, it should be apparent that the examples may be modified in arrangement and detail without departing from such principles. Skilled persons, therefore, will appreciate that many changes may be made to the details of the above-described embodiments without departing from the underlying principles of the invention. The scope of the present invention should, therefore, be determined only by the following claims.

1. An optical beam delivery device for producing, from a single-mode input beam having a fundamental mode and an M² beam quality of about 1.5 or less, an output beam having an adjustable spatial intensity distribution that is adjustable between near Gaussian and ring-shaped profiles, the near Gaussian profile corresponding to an M² beam quality of about 1.5 or less, the optical beam delivery device comprising:
a first length of optical fiber for adjusting the single-mode input beam to generate an adjustable beam based on controllable perturbation applied to the first length of optical fiber such that, in response to the first length of optical fiber being unperturbed, the single-mode input beam propagates through a central region of the first length of optical fiber to provide the adjustable beam, and in response to the controllable perturbation, the fundamental mode is at least partly displaced into an outer region of the first length of optical fiber to provide the adjustable beam;
a second length of optical fiber for coupling the adjustable beam into one or both a central core confinement region and an annular higher-index confinement region of a second length of optical fiber, the annular higher-index confinement region coaxially encompassing an annular anti-guiding region separating the central core confinement region from the annular higher-index confinement region, the second length of optical fiber configured to provide at its output the output beam having the adjustable spatial intensity distribution that is adjustable between the near Gaussian and ring-shaped profiles.

2. The optical beam delivery device of claim 1, in which the central core guiding region has a radius in a range from about three μm to about 15 μm.

3. The optical beam delivery device of claim 1, in which a coupling efficiency for the central region of the first length of optical fiber and the central core confinement region of the second length of optical fiber is greater than 95% in response to the first length of optical fiber being unperturbed.

4. The optical beam delivery device of claim 1, in which the controllable perturbation comprises different states of bending of the first length of optical fiber.

5. The optical beam delivery device of claim 4, in which the first length of optical fiber is further configured to, in response to different intermediate states of the controllable perturbation, produce different corresponding divisions of power localized the central core confinement region and the annular higher-index confinement region.

6. The optical beam delivery device of claim 1, in which a refractive index of the annular anti-guiding region results in an NA in a range that is greater than or equal to about 0.04 and less than or equal to about 0.1 for guidance of the central core confinement region, and the annular high-index confinement region has a refractive index resulting in an NA in a range that is greater than or equal to about 0.12 and less than or equal to about 0.2 for the guidance of the annular high-index confinement region.

7. The optical beam delivery device of claim 1, in which an NA of the annular higher-index confinement region is about 0.14 and an NA of the central core confinement region is about 0.07.

8. A method of producing, from a single-mode input beam having a fundamental mode and an M² beam quality of about 1.5 or less, an output beam having an adjustable spatial intensity distribution that is adjustable between near-Gaussian and ring-shaped profiles, the near-Gaussian profile corresponding to an M² beam quality of about 1.5 or less, the method comprising:
perturbing the single-mode input beam propagating within a first length of optical fiber to generate an adjustable beam based on controllable perturbation applied to the first length of optical fiber such that, in response to the first length of optical fiber being unperturbed, the single-mode input beam propagates through a central region of the first length of optical fiber to provide the adjustable beam, and in response to the controllable perturbation, the fundamental mode is at least partly displaced into an outer region of the first length of optical fiber to provide the adjustable beam;
coupling the adjustable beam into one or both a central core confinement region and an annular higher-index confinement region of a second length of optical fiber, the annular higher-index confinement region coaxially encompassing an annular anti-guiding region separating the central core confinement region from the annular higher-index confinement region; and
maintaining the adjustable beam within the second length of optical fiber to provide at its output the output beam having the adjustable spatial intensity distribution that is adjustable between the near Gaussian profile and the ring-shaped profile.

9. The method of claim 8, in which the central core guiding region has a radius in a range from about three μm to about 15 μm.

10. The method of claim 8, in which a coupling efficiency for the central region of the first length of optical fiber and the central core confinement region of the second length of optical fiber is greater than 95% in response to the first length of optical fiber being unperturbed.

11. The method of claim 8, in which the controllable perturbation comprises different states of bending of the first length of optical fiber.

12. The method of claim 11, in which the first length of optical fiber is further configured to, in response to different intermediate states of the controllable perturbation, produce different corresponding divisions of power localized the central core confinement region and the annular higher-index confinement region.

13. The method of claim 8, in which a refractive index of the annular anti-guiding region results in an NA in a range that is greater than or equal to about 0.04 and less than or equal to about 0.1 for guidance of the central core confinement region, and the annular high-index confinement region has a refractive index resulting in an NA in a range that is greater than or equal to about 0.12 and less than or equal to about 0.2 for the guidance of the annular high-index confinement region.

14. The method of claim 8, in which an NA of the annular higher-index confinement region is about 0.14 and an NA of the central core confinement region is about 0.07.
